(19) United States
(12) Patent Application Publication
(10) Pub. No.: US 2015/0146122 A1
(43) Pub. Date: May 28, 2015

(54) Trace Structure, Repair Method and Liquid Crystal Panel Thereof

(71) Applicant: Shenzhen China Star Optoelectronics Technology Co. Ltd., Shenzhen, Guangdong (CN)

(72) Inventor: Xiangyang Xu, Shenzhen (CN)

(73) Assignee: Shenzhen China Star Optoelectronics Technology Co. Ltd., Shenzhen, Guangdong (CN)

(21) Appl. No.: 14/239,108

(22) PCT Filed: Dec. 13, 2013
(86) PCT No.: PCT/CN2013/089346

§ 371 Date: Feb. 14, 2014

(30) Foreign Application Priority Data
Nov. 25, 2013 (CN) 201310603978.2

(51) Int. Cl. G02F 1/1362

(52) U.S. Cl. CPC G02F 1/136259; G02F 1/136286
USPC 349/42; 257/773; 438/4

(57) ABSTRACT

A trace structure is proposed. The trace structure includes a substrate, a shorting bar on the substrate and a plurality of data lines or scan lines, whose one end is connected to the shorting bar, on the substrate. The trace structure also includes an excessive shorting bar on the substrate. A break on a data line or a scan line is repaired by connecting the broken data line or scan line with one of the excessive shorting bar or the rest of the shorting bars. The present invention also proposes a repair method and a LCD panel using the trace structure. The simple trace structure and easy break repair operation not only raises repair efficiency but also lessens repair time and saves cost.

### BACKGROUND OF THE INVENTION

1. Field of Invention

The present invention relates to a liquid crystal display (LCD) field, more particularly, to a trace structure, a repair method and a liquid crystal panel thereof.

2. Description of the Prior Art

With technical development, information products have been invented enormously to meet different demands for consumers. Most of displays in the prior art are Cathode Ray Tube (CRT) display. Conventional CRT display has gradually been replaced by LCD because of disadvantages, such as bulky size, large energy consumption, harm to users by long-time radiation exposure.

LCD has been applied broadly on account of advantages, such as slimness, energy saving, non-radiation. Liquid crystal panel is the main component in an LCD. The working principle of liquid crystal panel is that arranging liquid crystal molecules between two parallel glass substrates and applying driving voltages on the two glass substrates to control rotational direction of the liquid crystal molecules, and light from a backlight module is refracted to generate images. The liquid crystal in the liquid crystal panel is driven by Thin Film Transistor (TFT). A producing process of a liquid crystal panel mainly comprises forepart array processing procedure, boxing processing procedure in a middle period and module assembly in a final period. To cost down, it usually simplifies the image detection of a liquid crystal panel in the boxing processing procedure and lessens equipment cost after the cut in the boxing processing procedure. An usage of shorting bar is the well-known way in the business, which means to cut off a connection between a shorting bar and a data line or scan line through laser after detection of images of the liquid crystal panel in the boxing period.

Electro-Static discharge (ESD) usually occurs in a process of a liquid crystal panel. It hardly prevents from dust particles in the process of the panel and easily leads to ESD therefore. Meanwhile, processes such as depositing, photoetching, etching, being stripped and washing, also cause ESD bringing about a break between a shorting bar and a data line or scan line. It leads to display abnormal of bright lines or dark lines in image detection in liquid crystal panel to influence detection of images. Therefore, it needs to repair ESD in a circuit first.

Please refer to FIG. 1, FIG. 1 shows a conventional trace structure comprising a substrate, shorting bars 110 on the substrate and a plurality of data lines or scan lines on the substrate and perpendicular to the shorting bars. To instruct conveniently, here takes three shorting bars and a plurality of data lines as an example. The shorting bars 110 comprise a first shorting bar 111, a second shorting bar 112 and a third shorting bar 113 parallel with each other. The data line 120 comprises a plurality of a first data line 121, a second data line 122 and a third data line 123 whose parallel ends respectively connected to the first shorting bar 111, the second shorting bar 112 and the third shorting bar 113 via holes. The first data line 121 crosses the second shorting bar 112 and the third shorting bar 113, and the second data line 122 intersects with the third shorting bar 113. Referring to FIG. 2, a break on a connection between the shorting bars 110 and the data line 120 extremely easily occurs when ESD happens. It finishes a repair just by welding an intersection 132 between the first data line 121 and the second shorting bar 112 or the third shorting bar 113 when a break on a connection 131 between the first data line 121 and the shorting bar 111 occurs. Similarly, it finishes a repair just by welding the intersection 132 between the second data line 122 and the third shorting bar 113 when a break on the connection 131 between the second data line 122 and the second shorting bar 112 occurs. If a break occurs on the connection 131 between the third data line 123 and the third shorting bar 113, however, the repair method does not work.

### SUMMARY OF THE INVENTION

To solve the above technical problem in the prior art, an object of the present invention is to provide a trace structure, a repair method and an LCD of the trace structure. The trace structure is being repaired while a break happens. Furthermore, the present invention has advantages of simple structure, convenient operation, shorter repair time and cost down.

According to the present invention, a trace structure comprises a substrate, a shorting bar on the substrate and a plurality of data lines or scan lines, whose one end is connected to the shorting bar, on the substrate. The trace structure further comprises an excessive shorting bar on the substrate.

In one aspect of the present invention, the excessive shorting bar is parallel to the shorting bar and intersects with but does not directly contact the data lines or the scan lines.

In another aspect of the present invention, a number of the shorting bar is plural. The data lines or the scan lines are connected to one of the shorting bars and are intersected with but does not directly contact the rest of the shorting bars.

In still another aspect of the present invention, the data lines or the scan lines are connected to one of the shorting bars via holes.

According to the present invention, a repair method for the trace structure comprises:

A. searching a broken shorting bar and a data line or scan line; and

B. connecting the broken scan line or data line to one of the rest of the shorting bars or an excessive shorting bar.

In one aspect of the present invention, the data lines or scan lines are connected to the rest of the shorting bars or the excessive shorting bar by welding.

In another aspect of the present invention, the excessive shorting bar is parallel to the shorting bar and intersects with but does not directly contact the data lines or the scan lines.

In another aspect of the present invention, a number of the shorting bar is plural.

In still another aspect of the present invention, the data lines or the scan lines are connected to one of the shorting bars and are intersected with but do not directly contact the rest of the shorting bars.

In yet another aspect of the present invention, the data lines or the scan lines are connected to one of the shorting bars via holes.

According to the present invention, a liquid crystal display panel comprises a color filter substrate, a thin film transistor (TFT) array substrate, and a liquid crystal layer therebetween. The TFT array substrate comprises the trace structure as mentioned above.

In one aspect of the present invention, the excessive shorting bar is parallel to the shorting bar and intersects with but does not directly contact the data lines or the scan lines.

In another aspect of the present invention, a number of the shorting bar is plural.

In still another aspect of the present invention, the data lines or the scan lines are connected to one of the shorting bars and are intersected with but does not directly contact the rest of the shorting bars.

In yet another aspect of the present invention, the data lines or the scan lines are connected to one of the shorting bars via holes.

The trace structure in the present invention repairs a break on a connection between a data line or scan line and shorting bars, caused by ESD or other reasons, via an arrangement of excessive shorting bars. The simple trace structure and easy break repair operation not only raises repair efficiency but also lessens repair time and saves cost.

### BRIEF DESCRIPTION OF THE DRAWINGS

FIG. 1 shows a conventional trace structure.

FIG. 2 shows a repair method using the trace structure as shown in FIG. 1.

FIG. 3 shows a trace structure of a liquid crystal panel according to a preferred embodiment of the present invention.

FIG. 4 shows a repair method using the trace structure as shown in FIG. 3.

FIG. 5 shows a liquid crystal panel according to a preferred embodiment of the present invention.

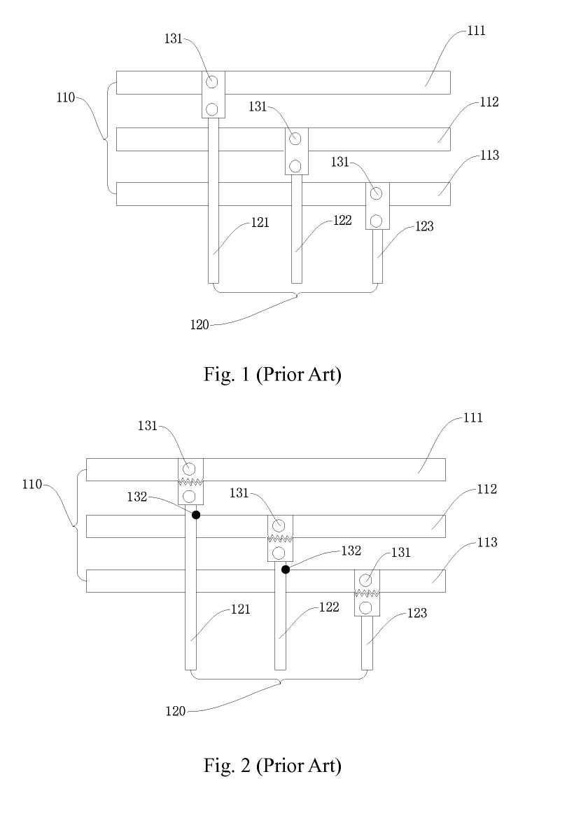

### DETAILED DESCRIPTION OF THE PREFFERED EMBODIMENT

The present invention is described in detail in conjunction with the accompanying drawings and embodiments.

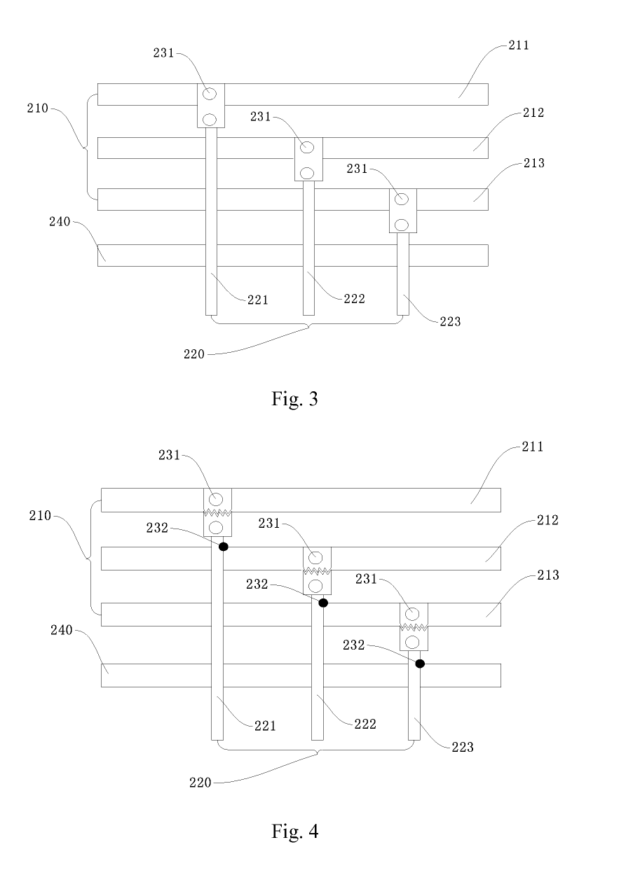

Refer to FIG. 3, FIG. 3 shows a trace structure of a liquid crystal panel of the embodiment comprising a substrate, shorting bars 210 on the substrate and a plurality of data lines or scan lines on the substrate and perpendicular to the shorting bars. To instruct conveniently, here takes three shorting bars and a plurality of data lines as an example. The shorting bars 210 comprise a first shorting bar 211, a second shorting bar 212 and a third shorting bar 213 parallel with each other. The data line 220 comprises a plurality of a first data line 221, a second data line 222 and a third data line 223 whose parallel ends respectively connected to the first shorting bar 211, the second shorting bar 212 and the third shorting bar 213 via holes. The first data line 221 crosses but does not directly contact the second shorting bar 212 and the third shorting bar 213, and the second data line 222 intersects with but does not directly contact the third shorting bar 213. An excessive shorting bar 240 parallel with the shorting bars 210 is set up on the substrate. The first data line 221, the second data line 222 and the third data line 223 all intersect with but does not directly contact the excessive shorting bar 240. The trace structure is simple, easy to operate and largely raises repair efficiency when a break occurs.

Beside the above-mentioned trace structure, the embodiment further provides a repair method. The method comprises the following steps:

A. searching the break on a connection between the shorting bar 210 and the data line or scan line;

B. connecting the broken scan line or data line to one of the rest of the shorting bars 210 or the excessive shorting bar 240.

Refer to FIG. 4. Specifically, it finishes a repair by laser welding an intersection 232 between the first data line 221 and the second shorting bar 212 when a break on a connection 231 between the first data line 221 and the shorting bar 211, caused by ESD or other reasons, occurs. In other embodiments, it also finishes a repair by welding or other ways to connect the first data line 221 to the third shorting bar 213 or the excessive shorting bar 240. Similarly, it finishes a repair by welding or other ways to connect the second data line 222 to the third shorting bar 213 or the excessive shorting bar 240 when a break on the connection 231 between the second data line 222 and the second shorting bar 212 occurs. It finishes a repair by welding or other ways to connect the third data line 223 to the excessive shorting bar 240 when a break on the connection 231 between the third data line 223 and the third shorting bar 213 occurs. The simple and convenient repair method not only raises the repair efficiency, but also shortens repair time and saves cost.

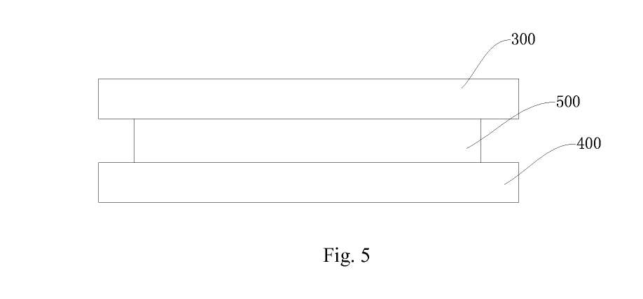

Refer to FIG. 5. A liquid crystal panel of an embodiment according to the present invention comprises a color filter (CF) substrate 300, a TFT array substrate 400 and a liquid crystal layer 500 between the color filter substrate 300 and the TFT array substrate 400. The liquid crystal layer 500 comprises a plurality of liquid crystal molecules. The color filter substrate 300, opposite to the TFT array substrate 400, generally comprises a transparent substrate (such as glass substrate) and black matrix pictures, color photoresist layers (such as red, green and blue filter pictures) and alignment layers on the transparent substrate. Owing to the color filter substrate 300 in the present invention is identical to a color filter substrate of a liquid crystal panel in the prior art, the specific structure of the color filter substrate 300 refers to relevant techniques and is not described further here.

The TFT array substrate 400, also called TFT substrate, generally comprises a transparent substrate (like glass substrate) and a plurality of TFTs on the transparent substrate in array. The TFT substrate 400 is mainly used for providing driving voltages to liquid crystal molecules in the liquid crystal layer 500 to deflect the liquid crystal molecules, and therefore, light passes through the liquid crystal layer 500 and then fits for the color filter substrate 300 so that the liquid crystal panel displays images. The above trace structure is set up on the TFT array substrate 400.

In sum, the present invention provides a trace structure that repairs a break on a connection between a data line or scan line and shorting bars, caused by ESD or other reasons, via an arrangement of excessive shorting bars. The simple trace structure and easy break repair operation not only raises repair efficiency but also lessens repair time and saves cost.

The terms “a” or “an”, as used herein, are defined as one or more than one. The term “another”, as used herein, is defined as at least a second or more. The terms “including” and/or “having” as used herein, are defined as comprising. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A trace structure, comprising a substrate, a shorting bar on the substrate and a plurality of data lines or scan lines, whose one end is connected to the shorting bar, on the substrate, wherein the trace structure further comprises an excessive shorting bar on the substrate.

2. The trace structure of claim 1, wherein the excessive shorting bar is parallel to the shorting bar and intersects with but does not directly contact the data lines or the scan lines.

3. The trace structure of claim 2, wherein a number of the shorting bar is plural, and the data lines or the scan lines are connected to one of the shorting bars and are intersected with but does not directly contact the rest of the shorting bars.

4. The trace structure of claim 1, wherein a number of the shorting bar is plural, and the data lines or the scan lines are connected to one of the shorting bars and are intersected with but does not directly contact the rest of the shorting bars.

5. The trace structure of claim 4, wherein the data lines or the scan lines are connected to one of the shorting bars via holes.

6. A repair method for a trace structure as claimed in claim 1, comprising:
A. searching a broken shorting bar and a data line or scan line;
B. connecting the broken scan line or data line to one of the rest of the shorting bars or an excessive shorting bar.

7. The repair method of claim 6, wherein the data lines or scan lines are connected to the rest of the shorting bars or the excessive shorting bar by welding.

8. The repair method of claim 6, wherein the excessive shorting bar is parallel to the shorting bar and intersects with but does not directly contact the data lines or the scan lines.

9. The repair method of claim 8, wherein a number of the shorting bar is plural, and the data lines or the scan lines are connected to one of the shorting bars and are intersected with but does not directly contact the rest of the shorting bars.

10. The repair method of claim 6, wherein a number of the shorting bar is plural.

11. The repair method of claim 10, wherein the data lines or the scan lines are connected to one of the shorting bars and are intersected with but do not directly contact the rest of the shorting bars.

12. The repair method of claim 11, wherein the data lines or the scan lines are connected to one of the shorting bars via holes.

13. A liquid crystal display panel comprising a color filter substrate, a thin film transistor (TFT) array substrate, and a liquid crystal layer therebetween, the TFT array substrate comprising a trace structure as claimed in claim 1.

14. The liquid crystal display panel of claim 13, wherein the excessive shorting bar is parallel to the shorting bar and intersects with but does not directly contact the data lines or the scan lines.

15. The liquid crystal display panel of claim 14, wherein a number of the shorting bar is plural, and the data lines or the scan lines are connected to one of the shorting bars and are intersected with but does not directly contact the rest of the shorting bars.

16. The liquid crystal display panel of claim 13, wherein a number of the shorting bar is plural.

17. The liquid crystal display panel of claim 13, wherein the data lines or the scan lines are connected to one of the shorting bars and are intersected with but does not directly contact the rest of the shorting bars.

18. The liquid crystal display panel of claim 17, wherein the data lines or the scan lines are connected to one of the shorting bars via holes.
